(19) United States
(12) Patent Application Publication
(10) Pub. No.: US 2018/0090006 A1
(43) Pub. Date: Mar. 29, 2018

(54) AUTOMOTIVE TARGET-DETECTION SYSTEM

(71) Applicant: MAZDA MOTOR CORPORATION, Hiroshima (JP)

(72) Inventors: Takahito IKENOUCHI, Hiroshima-shi (JP); Kanichi KOYAMA, Aki-gun (JP); Suguru KAWABATA, Aki-gun (JP)

(73) Assignee: MAZDA MOTOR CORPORATION, Hiroshima (JP)

(21) Appl. No.: 15/712,371

(22) Filed: Sep. 22, 2017

(30) Foreign Application Priority Data
Sep. 29, 2016 (JP) 2016-191071

(51) Int. Cl. G08G 1/16; G01S 17/93; G01S 17/02; G01S 13/93; G06K 9/00

(52) U.S. Cl. CPC G08G 1/163; G01S 17/936; G06K 9/00805; G01S 13/931; G01S 17/023

(57) ABSTRACT

An automotive target-detection system includes: sensor units each provided on a vehicle; and a central control unit connected to the sensor units. Each of the sensor units includes: a sensor detecting a target around the vehicle; and a controller generating target information on the detected target, and transmitting it to the central control unit. The controller (i) determines in which one of areas, into which a region around the vehicle is divided, each of targets detected by the sensor is present, (ii) calculates a priority of the targets based on a score set for the areas, (iii) transmits the target information on a target with high priority, (iv) avoids transmitting the target information on a target with low priority, and (v) changes the score of the areas depending on a driving condition.

### CROSS-REFERENCE TO RELATED APPLICATION

This application claims priority to Japanese Patent Application No. 2016-191071 filed on Sep. 29, 2016, the entire disclosure of which is incorporated by reference herein.

### BACKGROUND

The present disclosure relates to an automotive target-detection system detecting a target around a vehicle.

Vehicles are equipped with sensor units for detecting such targets as people and objects present around the vehicles themselves. For example, a front radar unit is provided to the front of a vehicle for detecting a target ahead of the vehicle. Target information on the target detected by the front radar unit is transmitted to an electronic control unit (ECU) acting as a central control unit. Based on the target information, the ECU determines the risk of collision between the vehicle and the target. When determining the risk of collision, the ECU implements such collision avoidance maneuvers as providing a warning to an occupant and actuating automatic brakes.

A sensor unit such as the front radar unit identifies a position of, and calculates a relative speed of, each of targets detected by the sensor unit. Hence, the number of the targets to be detected increases if a detection range of the sensor is excessively large. Thus, it takes extra time to identify positions, and calculates relative speeds, of all the targets, resulting in possible delay in target detection. In order to address such a problem, for example, Japanese Unexamined Patent Publication No. 2009-58316 discloses a technique to change a detection range of a radar device, depending on a driving speed and a steering angle, to limit the number of the targets to be detected.

Other than the front radar unit, recent vehicles are equipped with various kinds of sensor units such as a front horizontal radar unit, a front camera, a rear camera, and a rear horizontal radar unit. These sensor units can detect targets present around the 360 degrees of the vehicles. Hence, as the number of sensor units provided to a vehicle increases, target information to be transmitted to the ECU increases, which causes a problem of an increase in target information processing load on the ECU.

In order to address the problem, use of the technique disclosed in Japanese Unexamined Patent Publication No. 2009-58316 could limit the number of targets to be detected; however, if a blind spot appears when the detection range of a sensor is changed, the blind spot can incur the risk that the sensor misses detecting a target which might collide with the vehicle.

The present disclosure is conceived in view of the above problems, and attempts to detect, without missing, a target in a predetermined detection range, and to reduce processing load on an ECU.

### SUMMARY

The present disclosure presents an automotive target-detection system which attempts to detect, without missing, a target in a predetermined detection range, and to reduce processing load on an ECU.

Specifically, the automotive target-detection system includes: sensor units each provided to a predetermined position on a vehicle; and a central control unit connected to the sensor units via an in-car bus; wherein each of the sensor units includes: a sensor detecting a target around the vehicle; and a sensor controller generating target information on the target detected by the sensor, and transmitting the target information to the central control unit via the in-car bus, and the sensor controller (i) determines in which one of areas, into which a region around the vehicle is divided, each of targets detected by the sensor is present, (ii) calculates a priority of each of the targets based on a score set for the areas, (iii) transmits to the central control unit the target information on a target whose priority is high, (iv) avoids transmitting to the central control unit the target information on an other target whose priority is low, and (v) changes the score of each of the areas depending on a driving condition of the vehicle, the target and the other target being included in the targets.

Such features assign a priority to each of the targets depending on whether the target, detected by a sensor in each of the sensor units, is present in which area around the vehicle. Target information on a target having a high priority is transmitted to the central control unit, and target information on a target having a low priority is not transmitted to the central control unit. Hence, each sensor unit detects all the targets to be detected without a blind spot, and transmits to the central control unit target information on a target having a high collision risk only. This makes it possible to detect the targets in a predetermined detection range without missing, reduce the amount of the target information to be transmitted to the central control unit, and as a result, reduce the processing load on the central control unit. Furthermore, the score of each area may be changed depending on a driving condition of the vehicle such that the score of each area may be set to an appropriate value depending on a driving situation of the vehicle.

The driving condition may include a traveling direction of the vehicle.

The risk of collision with each of the targets varies depending on whether the vehicle moves forward or backward. As can be seen, changing the score of each area, depending on the traveling direction of the vehicle, allows the score of each area to be set to an appropriate value reflecting a difference in collision risk between the vehicle moving forward and the vehicle moving backward.

The driving condition may include a speed of the vehicle.

The risk of collision between the vehicle and each of the targets differs, depending on the running speed of the vehicle. As can be seen, changing the score of each area, depending on the speed of the vehicle, allows the score of each area to be set to an appropriate value reflecting a difference in collision risk due to a vehicle speed.

The areas may include a first area ahead and side of the vehicle and a second area immediately behind the vehicle, and when the vehicle moves forward at a high speed, the sensor controller sets a score of the second area higher than a score of the first area.

When the vehicle is running on a freeway, there is a decrease in the risk of another vehicle coming in front of the vehicle from ahead and the side of the vehicle. Meanwhile, there is an increase in the risk of another vehicle colliding with the vehicle from behind. As can be seen, when the vehicle is running at a high speed, the score of the area immediately behind the vehicle is set higher than the score of the forward side area of the vehicle. Such a feature makes it possible to assign a high priority to a target having a higher risk of a collision with the vehicle from behind.

The areas may include a first area immediately ahead of the vehicle and a second area far behind the vehicle, and when the vehicle moves backward at a low speed, the sensor controller sets a score of the first area higher than a score of the second area.

When the vehicle K-turns in parking lots, the vehicle would have a higher risk of collision with a target present immediately ahead of the vehicle than with a target present far behind the vehicle. As can be seen, when the vehicle moves backward at a low speed, the score of the area immediately ahead of the vehicle is set higher than the score of the area far behind the vehicle. Such a feature makes it possible to assign a high priority to a target having a high risk of a collision.

As can be seen, the present disclosure may detect, without missing, a target in a predetermined detection range, and to reduce processing load on a central control unit (ECU). Furthermore, the score of each area around the vehicle may be set to an appropriate value depending on a driving situation of the vehicle, therefore contributing to ensuring safety measures such as a collision avoidance maneuver.

### BRIEF DESCRIPTION OF THE DRAWINGS

FIG. 1 is a plan view of a vehicle illustrating various kinds of sensor units provided to the vehicle, and a detection range of the sensor units.

FIG. 2 is a block diagram of an automotive target-detection system according to an embodiment.

FIG. 3 is an example illustration of multiple areas defined in a region around the vehicle.

FIG. 4 is a flow chart illustrating how target information is transmitted by a sensor CPU.

FIG. 5 is a schematic view illustrating an example of how targets to be detected by a front camera are distributed ahead of the vehicle.

### DETAILED DESCRIPTION

Embodiments will be described hereinafter in detail with reference to the drawings. Note that overly detailed descriptions can be omitted. For example, a detailed description of a well-known issue and overlapping descriptions for substantially the same structure may be omitted. This is to keep the descriptions below from being unnecessarily redundant, and help those skilled in the art understand the descriptions.

Note that the inventors provide the drawings and the descriptions below to help those skilled in the art thoroughly understand the present disclosure, not to intend to limit the subject matter recited in the claims. Moreover, a size, a thickness, and a particular shape of a detail of each of the members drawn in the drawings may vary from an actual size, thickness, and shape.

### <<Example of Mounting Sensor Unit on Vehicle>>

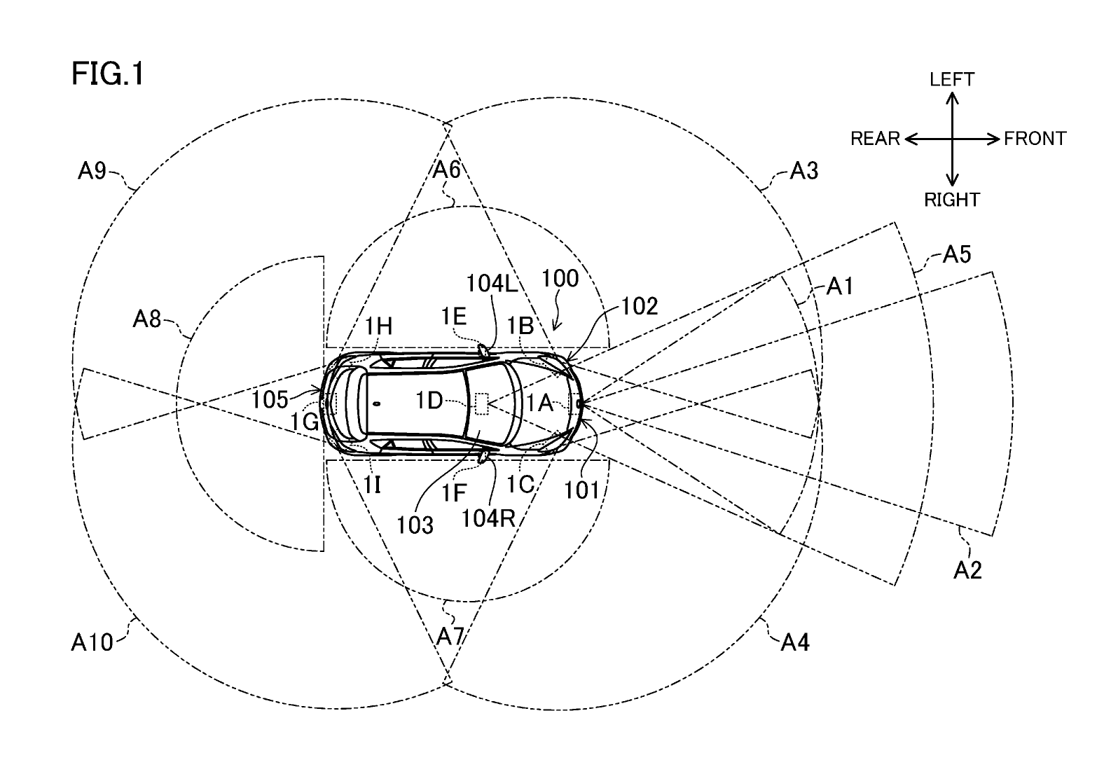

Described first is an example of mounting various kinds of sensor units detecting targets around the vehicle. FIG. 1 is a plan view, of a vehicle, illustrating various kinds of sensor units provided to the vehicle and a detection range of the sensor units. A vehicle 100 is equipped with multiple (nine in this example) sensor units 1A to 1I.

A sensor unit 1A (a front radar unit) is provided to a front center (e.g., a center position of a front grill 101) of the vehicle 100. A sensor unit 1B (a front left radar unit) is provided to, for example, a left position of a front bumper 102. A sensor unit 1C (a front right radar unit) is provided to, for example, a right position of the front bumper 102. Furthermore, a sensor unit 1D (a front camera) is provided to a front center (e.g., a top-center position of a windshield 103) of the vehicle 100. A sensor unit 1E (a front left camera) is provided to a left side (e.g., a left door mirror 104L) of the vehicle 100. A sensor unit 1F (a front right camera) is provided to a right side (e.g., a right door mirror 104R) of the vehicle 100. Moreover, a sensor unit 1G (a rear camera) is provided to a rear center (e.g., near a not-shown rear license plate) of the vehicle 100. A sensor unit 1H (a rear left radar unit) is provided to a left rear (e.g., a left position of a rear bumper 105) of the vehicle 100. A sensor unit 1I (a rear right radar unit) is provided to a right rear (e.g., a right position of the rear bumper 105) of the vehicle 100.

Each of the sensor units 1A to 1I includes one or more not-shown sensors. Millimeter wave radar, infrared laser radar, sonar, and a camera may be used as the sensors.

The millimeter wave radar emits a millimeter wave and receives a reflection of the millimeter wave to detect a target. The millimeter wave radar is resistant to rain and fog, and insusceptible to weather. The millimeter wave radar has a long effective range of 100 meters to 200 meters, which is suitable to detect a relatively distant target.

The infrared laser radar emits an infrared laser and receives a reflection of the infrared laser to detect a target. The infrared laser radar is less expensive than the millimeter wave radar. The infrared laser radar has a short effective range of several dozen meters, which is suitable to detect a relatively near target.

The sonar emits a sound wave and receives a reflection of the sound wave to detect a target. The sonar has an effective range of approximately one meter, which is suitable to detect a very closely positioned target.

The camera obtains an optical image, and generates image data. The generated image data is processed by an image processer so that a target in the image may be detected. The camera includes a charge-coupled device (CCD) camera and a complementary metal-oxide semiconductor (CMOS) camera, depending on a difference in image sensors to be used. The former obtains a high-resolution image. The latter operates with low power consumption. The camera has such advantages as a long effective range of several hundred meters and a wider viewing angle than the radar, the laser radar, and the sonar have. However, the camera has a disadvantage in that a target is less likely to be detected at night, in the dark, and in bad weather such as rain or fog.

Each of the sensors is used alone or in combination, depending on a requirement for the sensor units 1A to 1I. For example, in the sensor unit 1A, the millimeter wave radar and the infrared laser radar are used in combination.

A detection range of each of the sensor units 1A to 1I is illustrated with dash-dot-dot lines in FIG. 1. The sensor unit 1A covers an area (a range A1) ahead of, and relatively close to, the vehicle 100 to an area (a range A2) distant from the vehicle 100. The sensor unit 1B covers an area (a range A3) to the left and ahead of the vehicle 100. The sensor unit 1C covers an area (a range A4) to the right and ahead of the vehicle 100. The sensor unit 1D covers an area (a range A5) which stretches far ahead of the vehicle 100 at a wide angle. The sensor unit 1E covers an area (a range A6) to the left of the vehicle 100 at a wide angle. The sensor unit 1F covers an area (a range A7) to the right of the vehicle 100 at a wide angle. The sensor unit 1G covers an area (a range A8) behind the vehicle 100 at a wide angle. The sensor unit 1H covers an area (a range A9) to the left and behind the vehicle 100. The sensor unit 1I covers an area (a range A10) to the right and behind the vehicle 100.

As can be seen, the sensor units 1A to 1I have detection ranges partially overlapping with one another and covering all around the vehicle 100 as a whole. Such a feature contributes to detecting targets present around the 360 degrees of the vehicle 100.

### <<Embodiment of Automotive Target-Detection System>>

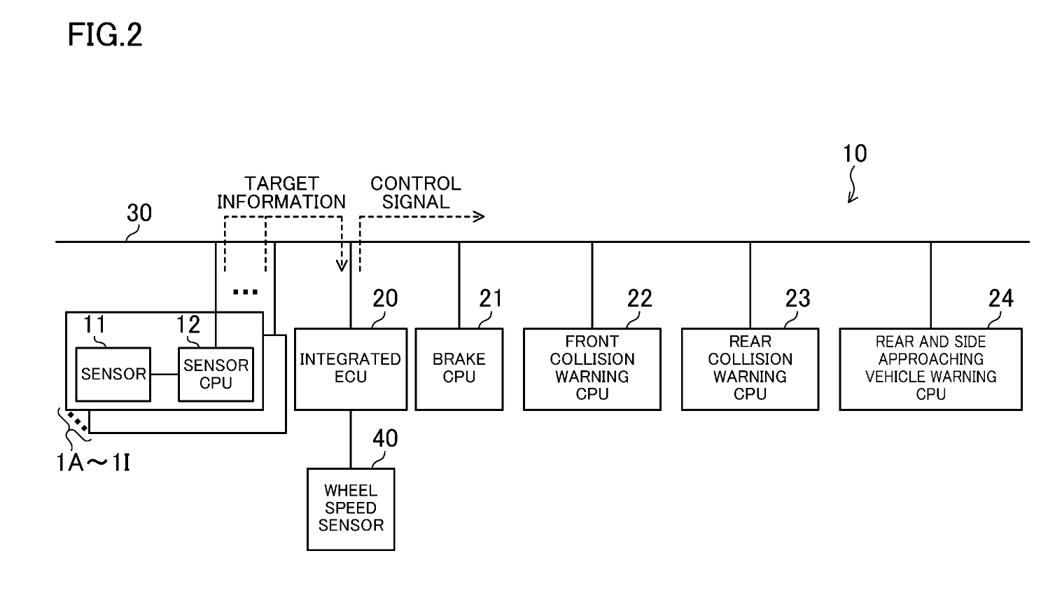

Described next is an embodiment of an automotive target-detection system mounted on the vehicle 100. FIG. 2 is a block diagram of an automotive target-detection system according to an embodiment.

An automotive target-detection system 10 according to this embodiment includes: the above sensor units 1A to 1I; and an integrated ECU 20 acting as a central control unit. The sensor units 1A to 1I and the integrated ECU 20 are connected to each other via an in-car bus 30 such as Controller Area Network (CAN®).

Other than the sensor units 1A to 1I and the integrated ECU 20, a brake CPU 21, a front collision warning CPU 22, a rear collision warning CPU 23, and a rear and side approaching vehicle warning CPU 24 are also connected to the in-car bus 30. Roles of these CPUs are described below. The brake CPU 21 controls a brake hydraulic system of the vehicle 100. The front collision warning CPU 22 controls a warning to be provided when the vehicle 100 is likely to collide with a target ahead of the vehicle 100. The rear collision warning CPU 23 controls a warning to be provided when the vehicle 100 is likely to collide with a target behind the vehicle 100. The rear and side approaching vehicle warning CPU 24 controls a warning to be provided when a target approaches a rear and side of the vehicle 100.

Each of the sensor units 1A to 1I includes: a sensor 11; and a sensor CPU 12 acting as a sensor controller. The sensor 11 is either any one of, or a combination of, the above millimeter wave radar, the infrared laser radar, the sonar, and the camera.

The sensor 11 for each of the sensor units 1A to 1I detects various targets around a vehicle, and outputs a signal. The sensor CPU 12 controls the sensor 11, and also receives the signal from the sensor 11 to generate target information on each of the targets detected by the sensor 11. Specifically, the sensor CPU 12 assigns a unique ID to each of the targets to identify each target, and calculates a position and a relative speed of the target. The position of the target is given as coordinates on an x-y plane having a position of the vehicle 100 as an origin. The relative speed between the vehicle 100 and the target is calculated to be a positive value when the target moves away from the vehicle 100, and to be a negative value when the target comes closer to the vehicle 100. In addition, the sensor CPU 12 assigns a reliability level to each of the targets. The reliability level indicates likelihood of a position of the target.

The sensor CPU 12 of each of the sensor units 1A to 1I transmits the target information on each of the targets via the in-car bus 30 to the integrated ECU 20. The target information to be transmitted to the integrated ECU 20 includes an ID, a position (coordinate information), a relative speed, and a reliability level of the target.

The integrated ECU 20 receives the target information from each of the sensor units 1A to 1I, and recognizes targets present around the vehicle 100. As illustrated in FIG. 1, the sensor units have detection ranges partially overlapping with one another, and thus each of the sensor units can transmit the target information on the same target. The integrated ECU 20 eliminates such redundancy of the target information, and recognizes the target.

The integrated ECU 20 receives, from a wheel speed sensor 40, wheel speed information on the vehicle 100. Then, based on the target information received from the sensor units 1A to 1I and the wheel speed information received from the wheel speed sensor 40, the integrated ECU 20 identifies a target having a risk of collision with the vehicle 100, and transmits a control signal to, for example, the brake CPU 21, the front collision warning CPU 22, the rear collision warning CPU 23, and the lateral rear approaching vehicle warning CPU 24 in order to avoid a collision with the target. For example, based on the target information received from the sensor units 1A to 1I and the wheel speed information received from the wheel speed sensor 40, the integrated ECU 20 calculates a time to collision (TTC) to identify a target having the risk of the earliest collision with the vehicle 100, and appropriately transmits a brake command to the brake CPU 21 in order to avoid the collision with the target.

As described above, since much target information is transmitted from the sensor units 1A to 1I to the integrated ECU 20, not only the processing load on the integrated ECU 20 increases, but also the capacity of a bandwidth of the in-car bus 30 decreases due to communications between the sensor units 1A to 1I and the integrated ECU 20. Thus, the automotive target-detection system 10 according to this embodiment causes the sensor units 1A to 1I to transmit target information having a high priority only to the integrated ECU 20, and not to transmit target information having a low priority to the integrated ECU 20.

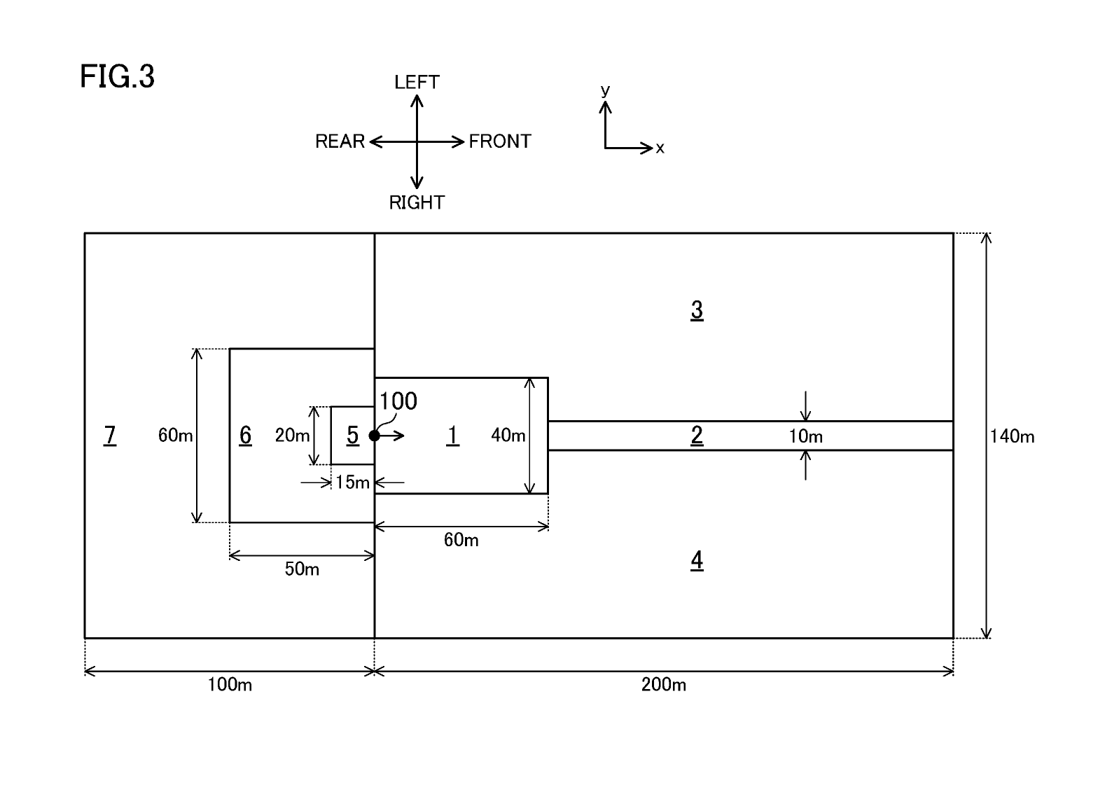

In order to prioritize targets, in this embodiment, a region around the vehicle 100 is divided into multiple areas, and a score (an area score) is set for each of the areas. FIG. 3 is an example illustration of the multiple areas defined in the region around the vehicle 100. In the example in FIG. 3, the region around the vehicle 100 is divided into seven areas. Note that, in FIG. 3, the vehicle 100 is indicated by a dot, and an arrow drawn from the dot indicates a traveling direction of the vehicle 100.

An area 1 corresponds to an area immediately ahead of the vehicle 100. The area 1 is a rectangular region having a width of 40 meters (20 meters each to the right and the left from the center of the vehicle 100), and a length of 60 meters (60 meters ahead of the center of the vehicle 100). The length 60 meters of the area 1 is determined based on a limit of the vehicle 100 to steer and avoid the collision.

An area 2 is an area further ahead of the area 1. The area 2 is a rectangular region having a width of 10 meters (five meters each to the right and the left from the center of the vehicle 100), and a length of 140 meters (140 meters from the 60-meter point ahead of the vehicle 100). The width of 10 meters for the area 2 is assumed to have a width for three traffic lanes.

The area 3 is an area to covera wide range from the left to the left and ahead of the vehicle 100. The area 3 is a remaining region of a rectangular region having a width of 70 meters (70 meters to the left from the center of the vehicle 100) and a length of 200 meters (200 meters ahead of the center of the vehicle 100) from which the area 1 and the area 2 are subtracted.

The area 4 is an area to cover a wide range from the right to the right and ahead of the vehicle 100. The area 4 is a remaining region of a rectangular region having a width of 70 meters (70 meters to the right from the center of the vehicle 100) and a length of 200 meters (200 meters ahead of the center of the vehicle 100) from which the area 1 and the area 2 are subtracted.

An area 5 corresponds to an area immediately behind the vehicle 100. The area 5 is a rectangular region having a width of 20 meters (10 meters each to the right and the left from the center of the vehicle 100), and a length of 15 meters (15 meters behind the center of the vehicle 100).

The area 6 is an area covering further behind, and both the right and left of, the area 5. The area 6 is a remaining region of a rectangular region having a width of 60 meters (30 meters to the right and the left from the center of the vehicle 100) and a length of 50 meters (50 meters behind the center of the vehicle 100) from which the area 5 is subtracted.

The area 7 is an area covering further behind, and both the right and left, of the area 6. The area 7 is a remaining region of a rectangular region having a width of 140 meters (70 meters to the right and the left from the center of the vehicle 100) and a length of 100 meters (100 meters behind the center of the vehicle 100) from which the area 5 and area 6 are subtracted.

The scores of the area 1 to the area 7 are set as seen in Table 1.

TABLE 1

| Area | Score |
|---|---|
| 1 | 50 |
| 2 | 30 |
| 3 | 15 |
| 4 | 15 |
| 5 | 15 |
| 6 | 5 |
| 7 | 0 |

Specifically, scores are set high for areas ahead of the vehicle 100 (i.e., areas in the traveling direction of, and immediately around, the vehicle 100)

A not-shown memory of each of the sensor units 1A to 1I stores a table indicating the above area scores and area information such as area boundary values. The area boundary values are given, for example, as coordinates on an x-y plane having the x-axis representing a length direction, the y-axis representing a width direction, and the origin representing the center of the vehicle 100. For example, the boundary values of the area 1 are given as x=60, and y=±20.

The sensor CPU 12 of each of the sensor units 1A to 1I calculates coordinates on the x-y plane for each of the targets detected by the sensor 11, compares the coordinates with the area boundary values, and determines in which one of the areas 1 to 7 each target is present. Then, the sensor CPU 12 calculates a priority of each of the targets based on the score of an area in which the target is present. In the order of priority, the sensor CPU 12 transmits, to the integrated ECU 20, target information on a predetermined number of targets, and avoids transmitting target information on a target other than the targets and having a low priority. For example, a target to be detected by the sensor unit 1A is present in any one of the area 1 to the area 4; however, the target information to be transmitted to the integrated ECU 20 with the first preference is one on the target present in the area 1; that is, the area immediately ahead of the vehicle 100. If the number of targets present in the area 1 is less than the predetermined number, transmitted to the integrated ECU 20 is target information on targets present in the areas 2 to 4.

The risk of collision with each of the targets varies depending on whether the vehicle moves forward or backward. For example, when the vehicle 100 moves forward, the risk of collision with a target ahead of the vehicle is higher than that with a target behind the vehicle. In contrast, when the vehicle 100 moves backward, the risk of collision with a target behind the vehicle is higher than that with a target ahead of the vehicle. Hence, the score of an area may be changed, depending on a driving condition of the vehicle 100.

For example, the scores of the area 1 to the area 7 are set as seen in Table 2.

TABLE 2
Moving Backward

| Area | Score |
|---|---|
| 1 | 15 |
| 2 | 0 |
| 3 | 0 |
| 4 | 0 |
| 5 | 50 |
| 6 | 30 |
| 7 | 15 |

The comparison between Table 1 (the scores of the areas when the vehicle 100 moves forward) and Table 2 shows that when the vehicle 100 moves backward, the scores of the areas ahead of the vehicle 100 are set low, and the scores of the areas behind the vehicle 100 are set high. For example, when the vehicle 100 moves forward, the score of the area immediately ahead of the vehicle 100 (the area 1) is “50”, and the score of the area immediately behind the vehicle 100 (the area 5) is “15.” In contrast, when the vehicle 100 moves backward, the score of the area immediately behind the vehicle 100 (the area 5) is set to the highest score of “50”, and the score of the area immediately ahead of the vehicle 100 (the area 1) is set to “15.” In addition, the score of the area 7 farthest behind the vehicle 100 is “0” when the vehicle 100 moves forward. The score is set to “15” when the vehicle 100 moves backward.

Furthermore, the risk of collision between the vehicle 100 and each of the targets changes, depending on the running speed of the vehicle 100. For example, suppose when the vehicle is running on a freeway. There is a decrease in the risk of another vehicle coming in front of the vehicle 100 from ahead and the side of the vehicle 100. Meanwhile, there is an increase in the risk of another vehicle colliding with the vehicle 100 from behind. Hence, the scores of the area 1 to the area 7 are set as seen in Table 3 when the vehicle 100 moves forward at a high speed.

TABLE 3
Moving Forward at High Speed (e.g., Freeway)

| Area | Score |
|---|---|
| 1 | 50 |
| 2 | 30 |
| 3 | 10 |
| 4 | 10 |
| 5 | 20 |
| 6 | 5 |
| 7 | 0 |

The comparison between Table 1 and Table 3 shows that when the vehicle 100 moves forward at a high speed, the score of the area immediately behind the vehicle 100 (the area 5) is set higher than the scores of the areas ahead and side of the vehicle 100 (the areas 3 and 4).

Furthermore, suppose when the vehicle 100 K-turns in parking lots. The vehicle 100 would have a higher risk of collision with a target present immediately ahead of the vehicle 100 than with a target present far behind the vehicle 100. Hence, the scores of the area 1 to the area 7 are set as seen in Table 4 when the vehicle 100 moves backward at a low speed.

TABLE 4
Moving Backward at Low Speed (e.g., K-turn)

| Area | Score |
|---|---|
| 1 | 15 |
| 2 | 0 |
| 3 | 0 |
| 4 | 0 |
| 5 | 50 |
| 6 | 30 |
| 7 | 5 |

The comparison between Table 2 and Table 4 shows that when the vehicle 100 moves backward at a low speed, the score of the area immediately ahead of the vehicle 100 (the area 1) is set higher than the score of the area far behind the vehicle 100 (the area 7).

A not-shown memory of each of the sensor units 1A to 1I stores tables indicating area scores for the vehicle 100 moving forward and backward in order to change the scores of the areas depending on a driving condition of the vehicle 100 as described above. The sensor CPU 12 of each of the sensor units 1A to 1I receives, from the integrated ECU 20, information on a traveling direction and a running speed of the vehicle 100, and calculates a priority of each of the targets based on the score of the area in which each target is present, with reference to an appropriate table in the memory depending on the traveling direction and the running speed of the vehicle 100.

Note that the sensor CPU 12 may determine a traveling direction and a running speed of the vehicle 100 based on such information as wheel speed information to be transmitted from the integrated ECU 20. Moreover, the sensor CPU12 may determine the traveling direction of the vehicle 100 either when a not-shown shift sensor directly inputs information on the shift sensor into each of the sensor unit 1A to 1I or when each of the sensor unit 1A to 1I receives the information on the shift sensor from the integrated ECU 20.

As can be seen, the automotive target-detection system 10 according to this embodiment may limit the number of target information items to be transmitted from the sensor units 1A to 1I to the integrated ECU 20, while allowing the sensor units 1A to 1I to detect, without missing, targets in a predetermined detection range. Such features may reduce processing load on the integrated ECU 20. Moreover, the features may provide more room to the bandwidth of the in-car bus 30. Furthermore, each of the sensor units 1A to 1I transmits target information having a high priority to the integrated ECU 20, which may ensure safety measures such as a collision avoidance maneuver.

In addition, each of the area 1 to the area 7 is shaped in a simple rectangle so that the sensor CPU 12 simply compares coordinates of each target with area boundary values to determine an area in which each target is present, reducing processing load on the sensor CPU 12. Such a feature may reduce the risk of delay in target detection processing by the sensor CPU 12.

Furthermore, the area scores may be changed depending on a driving condition of the vehicle 100 such that the score of each area may be set to an appropriate value depending on a driving situation of the vehicle 100, therefore contributing to ensuring safety measures such as a collision avoidance maneuver.

If a priority of a target is determined based only on an area score when many targets are detected in the area having the highest score, difference in priority cannot be made among the detected targets. Hence, as a factor to determine a priority of a target, a distance score and a relative speed score may be added. Here, the distance score reflects a distance between the vehicle 100 and a target, and the relative speed score reflects a speed of a target relative to the vehicle 100. A priority P of a target is represented by, for example, the following equation (1) where Sa is an area score, Sd is a distance score, and Sv is a relative speed score:

P=Sa+Sd+Sv (1)

The distance score Sd is represented by, for example, the following equation (2) where d [m] is a distance between the vehicle 100 and the target:

Sd=α×1/d (2)

The coefficient α is any given positive value. Specifically, the distance score Sd is higher as the target is present closer to the vehicle 100.

The relative speed score Sv is represented by, for example, the following equation (3) where v [km/h] is a relative speed of the target to the vehicle 100:

Sv=β×v (3)

Since the relative speed is calculated to be a positive value when the target moves away from the vehicle 100 and to be a negative value when the target comes closer to the vehicle 100, the coefficient β is set as an appropriate negative value. Specifically, the relative speed score Sv is higher as the target comes closer to the vehicle 100 at a faster speed.

Beneficially, the coefficients α and β are set in view of the resolution and the detection range of the sensor 11, and the sum of the distance score Sd and the relative speed score Sv is set not to exceed the minimum difference of the area score Sa. In the above example, the difference “5” between the score “5” of the area 6 and the score “0” of the area 7 corresponds to the minimum difference of the area score Sa. Hence, beneficially, the values of the coefficients α and β are set so that the relationship Sd+Sv<5 is satisfied. Such a feature makes it possible to determine a priority of a target in view of providing the first preference to an area in which a target is present, rather than in view of the distance to, and the relative speed of, the target.

More beneficially, the values of the coefficients α and β are set so that the distance score Sd is definitely higher than the relative speed score Sv. In the above example, the sum of the distance score Sd and the relative speed score Sv is smaller than “5”. Hence, the coefficients α and β are set so that, for example, the maximum value of the distance score Sd is “3” and the maximum value of the relative speed score Sv is “2”. Such a feature makes it possible to determine a priority of a target with the distance to the target prioritized over the relative speed of the target. For example, when an oncoming car distant from the vehicle 100 and a car ahead of, and closer to the vehicle 100 than the oncoming car are detected in the same area, the priority of the latter (the closer car ahead of the vehicle 100) is calculated higher than that of the former (the distant oncoming car).

Note that if the sensor 11 can determine not only the presence of the target but also the type of the target (e.g., a person or a vehicle), a score reflecting the type of the target may be included in the calculation of the priority of the target.

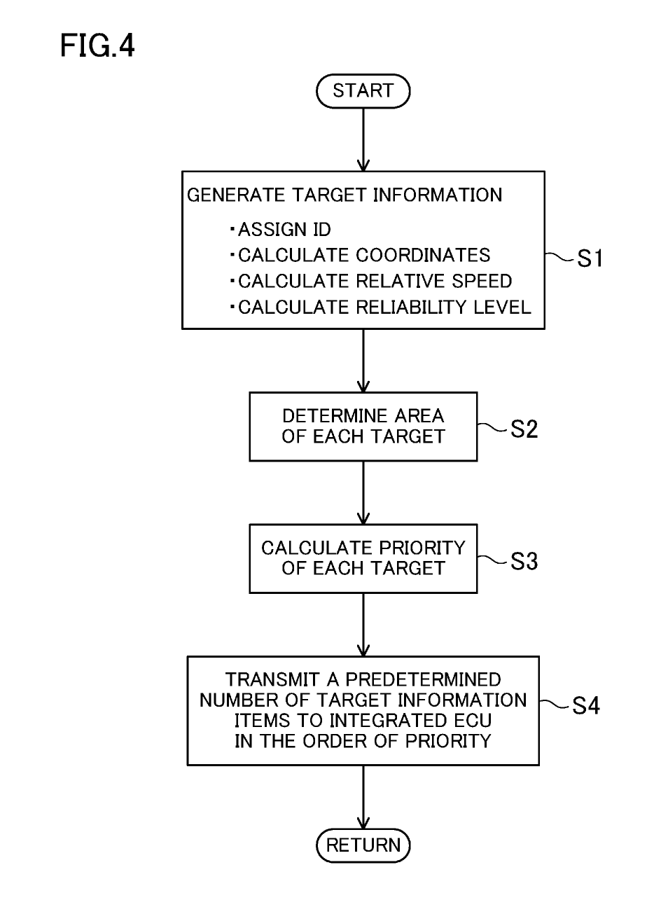

Described next is how target information is transmitted by the sensor CPU 12. FIG. 4 is a flow chart illustrating how target information is transmitted by the sensor CPU 12.

The sensor CPU 12 receives a target detecting signal from the sensor 11, and generates target information on each of the targets (S1). Specifically, the sensor CPU 12 assigns a unique ID to each of the targets, and calculates coordinates, a relative speed, and a reliability level of the target.

Next, the sensor CPU 12 determines in which one of the areas 1 to 7 each of the targets is present (S2). As described above, this area determination may be executed through a comparison between the coordinates of the target and an area boundary value.

When the determination of an area in which each target is present ends, the sensor CPU 12 calculates a priority of each of the targets according to Equation (1), with reference to the area scores stored in the not-shown memory (S3). Here, receiving from the integrated ECU 20 the wheel speed information on the vehicle 100, the sensor CPU 12 refers to appropriate area information depending on a traveling direction and a running speed of the vehicle 100. Note that the sensor units 1A to 1I are provided to various positions on the vehicle 100. Beneficially, any sensor unit may use the same area information and the same expression for calculating a priority of a target. Since the sensor CPUs 12 calculate the priority of the target on the same standard, the priority of the target can be calculated without being affected by differences in detection range and detection performance among the sensors.

When finishing the calculation of the priority of each of the targets, the sensor CPU 12 transmits a predetermined number of target information items to the integrated ECU 20 in the order of priority (S4). The predetermined number may be either fixed or appropriately changed by an instruction from the integrated ECU 20. Note that, regardless of the priority, the sensor CPU 12 may definitely transmit the target information on a target designated by the integrated ECU 20 (e.g., a target under monitoring by the integrated ECU 20 as a subject to a collision avoidance maneuver).

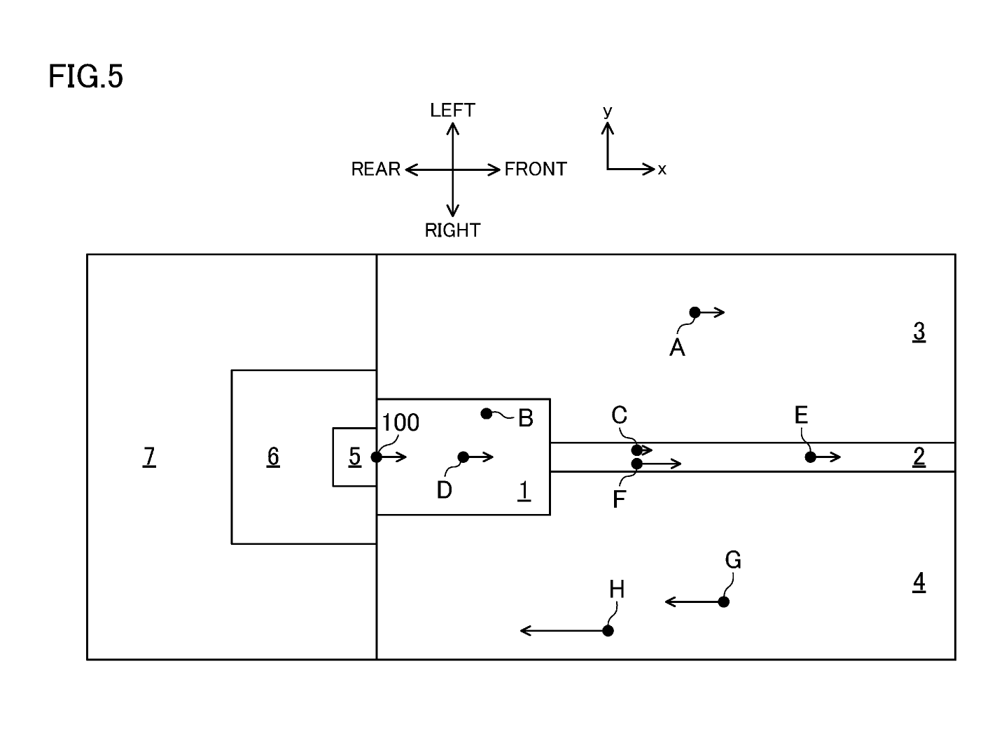

Described below is an example of priority calculation executed in Step S3. FIG. 5 is a schematic view illustrating an example of how targets to be detected by the sensor unit 1D (a front camera) are distributed ahead of the vehicle 100. Suppose a target A to a target H are present ahead of the running vehicle 100. For example, the target A is a vehicle running on another road in the same direction as the vehicle 100. The target B is a traffic sign or a vehicle parking at a road shoulder. The target C to the target F are vehicles running ahead of the vehicle 100. The target G and the target H are vehicles running on the opposite traffic lane. Note that, in FIG. 5, the directions of the arrows, extending from the dots representing the vehicle 100 and the target A to the target H, represent the traveling directions of the vehicles, and the lengths of the arrows represent the speeds of the vehicles. No arrow is found for the target B as a stationary object. Table 2 shows the following: areas in which the target A to the target H under the above conditions are present; the distances from the vehicle 100; relative speeds to the vehicle 100; and priorities. The coefficient α in Equation (2) is 3, and the coefficient β in Equation (3) is −4×10⁻⁷. In the table, the targets are sorted in descending order of priority.

TABLE 5

| | Presence | | Relative | |
|---|---|---|---|---|
| Target | Area | Distance | Speed | Priority |
| D | 1 | 30 | 0 | 50.1 |
| B | 1 | 40 | −40 | 50.075 |
| C | 2 | 90 | −10 | 30.0333 |
| F | 2 | 90 | 10 | 30.0272 |
| E | 2 | 150 | 0 | 30.02 |
| H | 4 | 90 | −100 | 15.0333 |
| A | 3 | 120 | 0 | 15.025 |
| G | 4 | 140 | −80 | 15.0214 |

As can be seen from this example of the priority calculation, the two highest priorities are assigned to the target D and the target B present in the area 1 to which the highest score (an area score of 50) is set. Following the target D and the target B, three second-highest priorities are assigned to the target C, the target E, and the target F present in the area 2 to which the second highest score (an area score of 30) is set. Low priorities are assigned to the target A, the target G, and the target H present in the area 3 and the area 4 (an area score of 15). Hence, the area scores are prioritized for the calculation of the priorities of the targets.

When multiple targets are present in the same area, a target closer to the vehicle 100 has a higher priority. For example, even though both of the targets B and D are present in the area 1, the target D closer to the vehicle 100 is calculated to have a priority higher than that of the target B. This is because the relative speed of the target B is more negative in value and faster than the relative speed of the target D, and the target B is more distant from the vehicle 100 than the target D is.

When multiple targets are present in the same area and, furthermore, are equally distant from the vehicle 100, difference in priority is determined based on relative speeds. For example, both of the targets C and F are present in the area 2 and are equally distant from the vehicle 100; however, the target C is calculated to have a priority higher than that of the target F. This is because the relative speed of the target C is more negative in value and faster than that of the target F.

As can be seen, the above embodiment is described as an example of the technique disclosed in the present disclosure. Hence, the drawings are attached and the detailed description is presented.

The constituent elements in the attached drawings and the detailed description may include not only those essential to solve the problems, but also those which might not be essential to solve the problems in order to show the technique as an example. Thus, those inessential constituent elements shall not be determined as essential ones simply because such elements are found in the attached drawings and the detailed description.

Moreover, the embodiment is an example to describe the technique disclosed in the present disclosure, and thus the embodiment may be changed, replaced with another embodiment, modified with an added embodiment, and omitted within a scope of claims and a scope equivalent to the claims.

What is claimed is:

1. An automotive target-detection system, comprising:
sensor units each provided to a predetermined position on a vehicle; and
a central control unit connected to the sensor units via an in-car bus; wherein
each of the sensor units includes: a sensor detecting a target around the vehicle; and a sensor controller generating target information on the target detected by the sensor, and transmitting the target information to the central control unit via the in-car bus, and
the sensor controller (i) determines in which one of areas, into which a region around the vehicle is divided, each of targets detected by the sensor is present, (ii) calculates a priority of each of the targets based on a score set for the areas, (iii) transmits to the central control unit the target information on a target whose priority is high, (iv) avoids transmitting to the central control unit the target information on an other target whose priority is low, and (v) changes the score of each of the areas depending on a driving condition of the vehicle, the target and the other target being included in the targets.

2. The automotive target-detection system of claim 1, wherein
the driving condition includes a traveling direction of the vehicle.

3. The automotive target-detection system of claim 1, wherein
the driving condition includes a speed of the vehicle.

4. The automotive target-detection system of claim 3, wherein
the areas include a first area ahead and side of the vehicle and a second area immediately behind the vehicle, and
when the vehicle moves forward at a high speed, the sensor controller sets a score of the second area higher than a score of the first area.

5. The automotive target-detection system of claim 3, wherein
the areas include a first area immediately ahead of the vehicle and a second area far behind the vehicle, and
when the vehicle moves backward at a low speed, the sensor controller sets a score of the first area higher than a score of the second area.
